(19) United States
(12) Patent Application Publication
(10) Pub. No.: US 2004/0088840 A1
(43) Pub. Date: May 13, 2004

(54) Aluminium foil rolling method

(76) Inventor: Dan Miller, Banbury, Oxfordshire (GB)

Correspondence Address: Richard S Milner, Cooper & Dunham, 1185 Avenue of the Americas, New York, NY, 10036, US

(21) Appl. No.: 10/468,551

(22) PCT Filed: Feb. 15, 2002
(86) PCT No.: PCT/GB02/00673

(30) Foreign Application Priority Data
Feb. 22, 2001 (EP) 01301589.6

(51) Int. Cl. B32B 31/00

(52) U.S. Cl. 29/17.6

(57) ABSTRACT

An aluminium foil rolling method comprising the steps of taking two strips of aluminium, bringing facing surfaces of the two strips into contact with one another and subjecting the two strips to a first pack rolling operation, thence subjecting the same two strips to a second pack rolling operation whilst maintaining the two strips in substantially the same registry as when the first pack rolling operation was carried out. Advantageously, following the first pack rolling operation, the two strips are coiled together onto a common coil in order to assist in maintaining their registry for the second pack rolling operation. In an embodiment, a release material is applied to the facing surfaces of at least one of the strips prior to bringing them together for the first pack rolling operation, and a further amount of release material, less than that applied before the first pack rolling operation, or even a zero amount, is applied between the two pack rolling operations.

The present invention relates to an improved aluminium foil rolling method. In particular, the present invention is concerned with the cold rolling of aluminium and its alloys in the production of thin gauge sheets or foils.

Among other uses, aluminium foil is widely used as a domestic wrapping material and usually has a gauge ranging from about 30 μm to about 5 μm. The foil is initially produced by conventional open-gap rolling processes in which a strip or sheet of aluminium is passed through a series of rolling mills or repeatedly passed through the same rolling mill to progressively reduce the metal gauge down to the desired thickness. At thinner gauges, for example less than 100 μm, the sheet is rolled under closed gap conditions in which the work-rolls are in contact with each other beyond the edges of the sheet. As the sheet gets thinner, it becomes increasingly difficult to transfer sufficient load onto the sheet to achieve further reductions in thickness. Hence, for very thin gauge sheets or foils, in the final pass the sheet is pack rolled (also known as a doubling pass).

The penultimate pass is usually called the split pass because the output from the mill is split into two (or more) separate daughter, coils. This is achieved by rolling a first length onto a first daughter coil, then cutting the sheet laterally across its width at the output of the mill, and coiling the subsequent mill output onto an empty spool to make a second daughter coil.

In the doubling pass the sheets from each of the two daughter coils are brought together and passed simultaneously through the mill stand with the facing surfaces of the two sheets that are in contact being coated with a separating or release material, for example in the form of oil, so that the two sheets can be separated after the doubling pass. A separate operation is used to trim the sheets, part the two sheets and wind them as individual coils.

Although in the final pass two sheets pass through the mill stand simultaneously, the total reduction in gauge for the split pass and the doubling pass are often similar.

The length of the sheet is at its maximum for the split and the doubling pass and so the time taken to roll the material is the longest for any pass. Accordingly it would be desirable to speed up the passage of sheet through the split and the doubling passes. However, although steps can be taken to speed up the split pass, the same is not true of the doubling pass. The metal quality of the final product should preferably not be compromised and at the thin foil gauges involved during the doubling pass, control of tension and edge quality is important if strip breakages are to be avoided.

In addition, problems can be encountered during the doubling pass arising from some degree of mismatch between the two sheets. For example, there may be differences in the average gauge, the strip profile or off-flatness between the two sheets, all of which can affect the quality of the resultant product. When aluminium is rolled, there is a requirement to keep the thickness of the sheet close to a specified value and within a specified tolerance of this value. Because of natural variation in the process and in the automated control systems employed to aid the task, the sheet comes out exhibiting a periodic variation in thickness along its length.

It is also highly desirable to keep the strip as flat as possible; however in practice all rolled sheet shows periodic variations in flatness that change through the length of the strip.

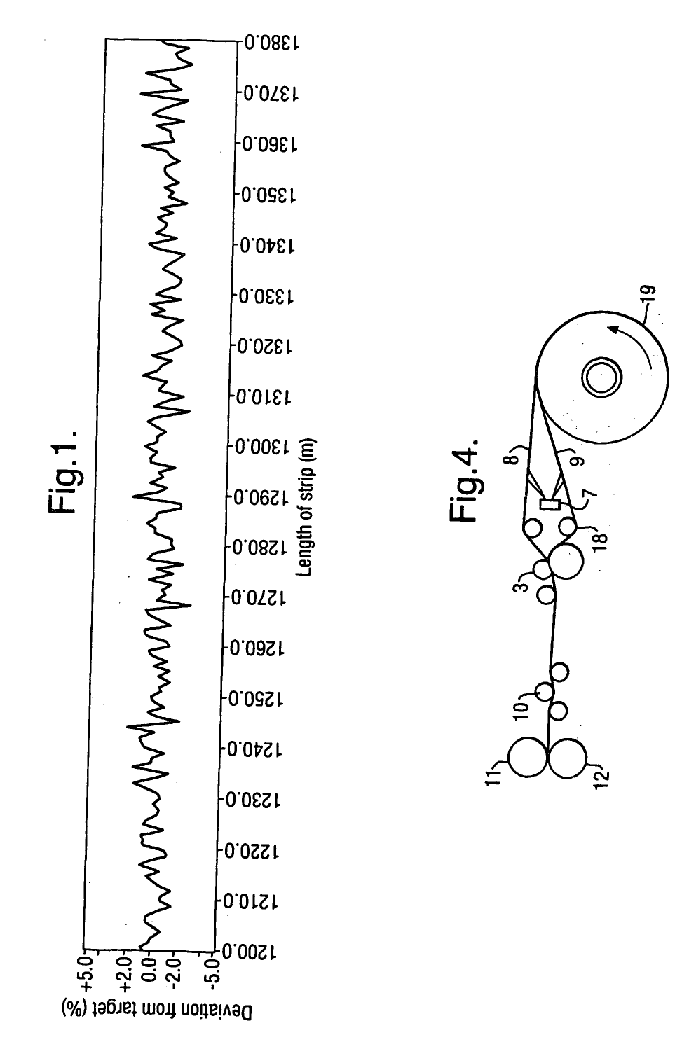

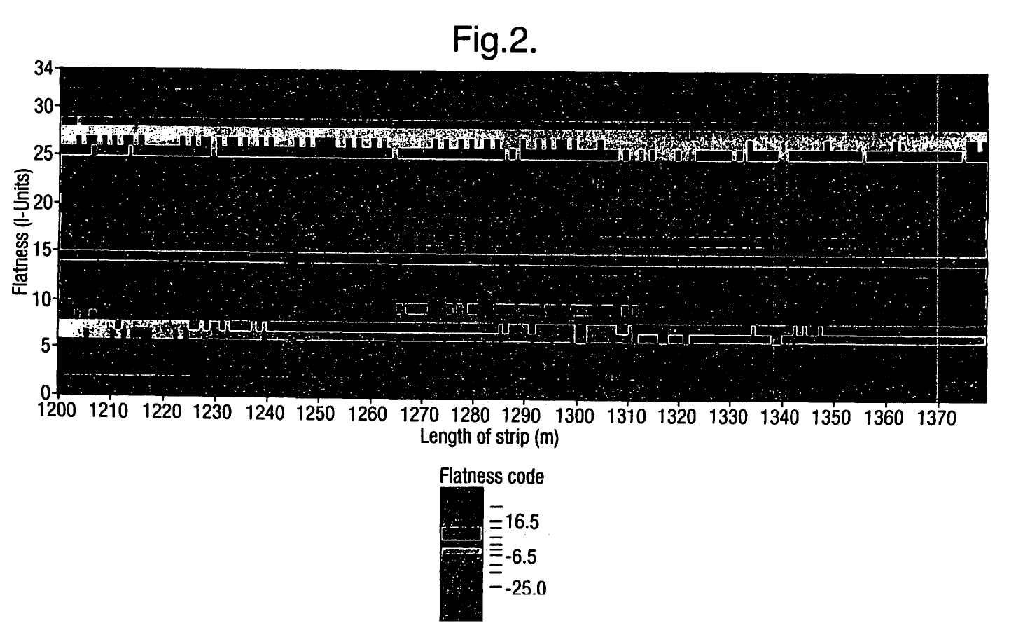

FIGS. 1 and 2 of the accompanying drawings give typical examples of measured thickness and flatness variation: FIG. 1 shows the percentage gauge variation in the elongate direction of the strip about a nominal gauge; FIG. 2 shows that the flatness distribution in i-units along the length of the strip changes from place to place on the strip.

If two sheets are brought in together into the roll bite as is done in pack rolling, differences in the sheet thickness and flatness of the two sheets at the same position can give rise to defects in th product quality. For example, if one of the sheets is thicker than average at the sam position where the other sheet is thinner than average, then the deformation of the two sheets at that point when passing through the rolling mill stand will not be the same, setting up a strain difference between the sheets. If the strain difference is sufficiently large this can cause slippage between the sheets or even buckling. The effect is more marked as the thicknesses of the sheets decreases.

In U.S. Pat. No. 4,680,250 a method of manufacturing a composite aluminium sheet for use in a lithographic printing plate is described in which the sheet is pack rolled more than once. The repeated pack rolling is performed in order to ensure a surface roughness of 0.20-0.65 μm Rₐ. With the method described in this document, the facing surfaces of the two sheets are fully separated and re-coated in oil prior to each repeated doubling pass.

The present invention seeks to provide an improved foil rolling method in which the overall production time can be reduced and the effect of the type of operational problems described above can be reduced.

The present invention provides a foil rolling method for producing thin gauge aluminium foil, said method comprising the steps of: providing two strips of aluminium; bringing the facing surfaces of the two strips into contact; and pack rolling the two strips, the method further comprising pack rolling the two strips at least once more wherein the second and any subsequent pack rolling steps are carried out with the two strips in the same, or substantially the same registry as when the first pack rolling step was carried out.

Thus the essence of the invention is to keep, as closely as possible, the two strips in registry as between the first and subsequent doubling passes. In other words, the two strips must, as closely as possible, be in the same longitudinal position with respect to one another, when passing through the second (and any subsequent) doubling passes as when passing through the first doubling pass. This longitudinal matching of the two strips ensures that, during the second and later doubling passes, any thickness and/or flatness variations that were incurred during the first doubling pass remain at substantially the same position for both strips.

The longitudinal matching of the strips should be as close as reasonably possible; however, small mismatches can be tolerated because the longitudinal wavelength of the thickness and flatness variations is quite significant, and mismatches which are small in comparison with the wavelength of the variations will be acceptable.

In an embodiment of the invention a release material, for example rolling oil, is applied to a facing surface of at least one of the strips prior to the first pack rolling step, and a further amount of release material is applied to the facing surfaces of the strips between the two pack rolling step, said further amount being less than the amount applied prior to the previous pack rolling step.

The two pack rolling steps may constitute the final passes, or they may be followed by one or more further passes, which further passes may or may not comprise doubling passes. If the two pack rolling steps do constitute the final passes, then they will preferably be followed by coiling the two strips, either together onto a common coil, or individually onto separate coils. If the two pack rolling steps are to be followed by further passes, then further release material may optionally be applied prior to the further passes.

Preferably the amount of release material applied between the two pack rolling steps is less than half the amount of release material applied prior to the first pack rolling step.

Ideally, no additional release material is applied between the two pack rolling steps in which case the two elongate strips need not be separated between the two pack rolling steps. This particularly applies if the two pack rolling steps constitute the final passes.

Depending on the gauge at which the first pack rolling step is started, at least one of the two pack rolling steps may be performed with the rolls in an open gap configuration.

There are two methods of handling the strip between the two pack rolling steps. In the first method, the two strips are continuously fed from the first pack rolling step to the second pack rolling step, being optionally separated for the purpose of applying said further release material. In th second method, the two strips are coiled after the first packing rolling step, and are subsequently uncoiled for application to the second pack rolling step. If the second method is used, it will be seen that the second pack rolling step may be carried out on the same set of rolls as the first pack rolling step.

The second method is the preferred method. In order to maintain registry between the two sheets, it is preferred that, after the first pack rolling step the two strips are not separated, but are coiled together, still in registry, onto a common, combined, coil. Thence, prior to the second pack rolling step, the two strips are uncoiled together from the combined coil, and may optionally be separated, prior to being passed through the work rolls for the second pack rolling step, for the application of said further release material. The combined coil thus becomes a source of a pair of aluminium foil strips which are matched in respect of gauge and flatness variations and are thus particularly suitable for use in final pass pack rolling.

As a result of this approach, the total production time can be greatly reduced as the length of the metal that passes through each of the mills does not achieve the length of the equivalent strip length using the conventional method. Indeed, the duration of the split pass can be halved if the reductions for the conventional split pass and conventional doubling pass are similar. Moreover, as the strips are pack rolled at least once before the final doubling pass, the two strips are better matched than in the conventional method for the final doubling pass and the extent of recovery losses due to mismatch in length are reduced.

Reference herein to aluminium is to be understood to encompass both the metal and its alloys that can be rolled into foils.

Embodiments of the present invention will now be described by way of example only and with reference to the accompanying drawings in which:—

FIG. 1 is a graph of gauge variation in the longitudinal direction of a length of a strip of aluminium which has been processed through multiple rolling passes;

FIG. 2 is a diagram of the flatness distribution along the same length of the strip of FIG. 1; and

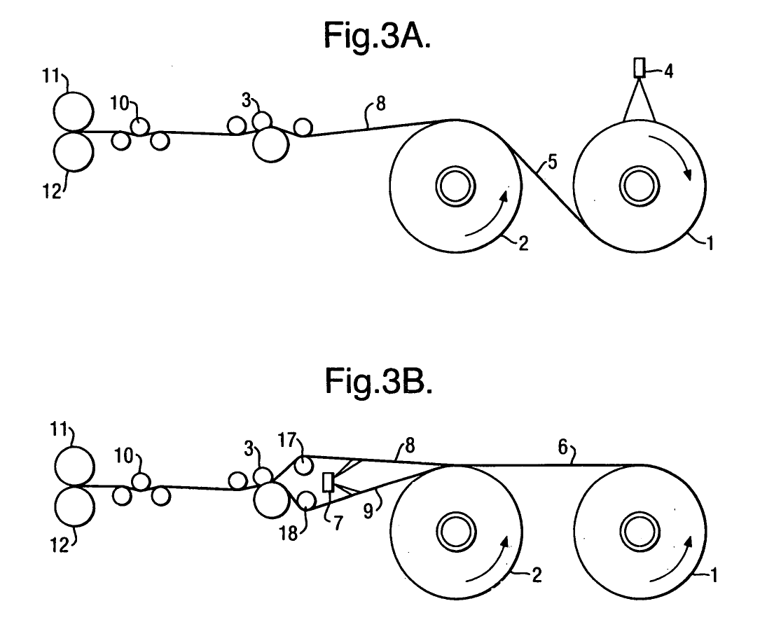

FIGS. 3 and 4 are diagrams illustrating apparatus suitable for performing the method of foil rolling in accordance with the present invention.

FIGS. 3A and 3B illustrates pack rolling on a mill that has an in-line doubling capability. In FIG. 3A two coils 1, 2 of metal foil are shown each supplying a separate strip of foil to an edge trim unit and a series of guide rolls 3. The two coils 1, 2 were produced using conventional apparatus—rolling mills—(not shown) by reducing the gauge of an initial strip of foil in successive mill stands and then splitting the strip into the two daughter strips which are individually coiled.

In order to unwind the coil 2, it is rotated anticlockwise and the strip emerges along a path indicated by the line 8.

In order to unwind the coil 1 it is also rotated anticlockwise, and a release medium, usually oil, is applied to the outer surface of the coil 1 from a spray bar 4.

The strip emerging from coil 1 passes along a path 5 and thence passes over the coil 2, as shown. As the strip from coil 1 passes over coil 2, it joins the strip emerging from coil 2, and the two strips travel together along the path 8 to the trim unit 3. It will be seen that the release medium from spray bar 4 is applied to that surface of the strip emerging from coil 1 that faces the strip emerging from coil 2; thus the two strips sandwich between them a thin layer of release medium. Beyond the trim unit, a set of bridle rolls 10 guide the strips between the work rolls 11, 12 of a mill stand, where they are reduced in thickness. The exit side of the mill stand is not shown. Though a two-high configuration of mill stand is shown in the drawing for clarity, it is more common to be rolling in a four-high configuration. The actual configuration is immaterial to this invention.

FIG. 3B is the same as FIG. 3A, except that it shows an alternative feeding arrangement from coil 1 and also an alternative way of applying release medium. In the arrangement of FIG. 3B, the coil 1 is rotated anticlockwise to unwind, and the strip emerges along a path indicated by the line 6. Meanwhile the strip emerging from coil 2 passes along a path indicated by the line 9. After passing over the coil 2, the strip emerging from coil 1 is separated from the strip emerging from coil 2, and passes along a path indicated by line 8. Separation is achieved by passing the strips over respective spaced rolls 17, 18. While separated, a release medium is sprayed between the two strips from a spray bar 7 before they are brought together again at the trim unit 3.

As an alternative to separate coils 1 and 2, the two daughter strips can be doubled on a separate machine whereby the two strips are coiled together onto a common coil while a separating medium, usually oil, is applied between the layers. The strips can but do not need to be trimmed together to give a combined coil of a predetermined width. The combined coil would then be brought to a conventional rolling mill, and reduced in thickness to the required gauge.

Pack rolling is done at least one pass earlier and for at least one additional pass in the process route.

The double layer of foil of reduced gauge, emerging from the first pass through the mill stand of FIG. 3, is next brought around to the same mill or to a different mill for at least one further doubling pass. Depending on the mill configuration, alternative methods can be used. In the first method, applicable to a tandem mill, the two strips emerging from the work rolls 11, 12 are passed in a continuous process to a further set of work rolls (not shown) where a second doubling pass is undertaken. Optionally, prior to entering the second set of work rolls, the strips are separated and release medium, in an amount less than was applied during the first doubling pass, is added in a similar manner to that shown in FIG. 3B (items 7, 17 and 18).

In a second method, the two strips emerging from the work rolls 11, 12 are coiled together onto a common coil. This combined coil, shown in FIG. 4 under reference 19 is then used to feed a second doubling pass in the arrangement shown in FIG. 4.

In the arrangement illustrated in FIG. 4, the completed coil 19 from the previous doubling pass, which coil consists of two strips coiled together, is at the inward position (i.e. where coil 2 was placed in the arrangement of FIG. 3). Prior to the trim unit 3, the two strips are separated and an additional amount of release medium applied from spray bar 7. The amount applied is less than was applied during the previous doubling pass. At the trim unit 3 the two strips of foil are brought back in contact with one another before passing via the bridle rolls 10 to the work rolls 11, 12 to reduce the gauge of the double layer of foil to the desired gauge of the foil. Beyond the mill stand, the double layer of foil is coiled conventionally. The exit side of the mill is not shown in the Figure. Again, the configuration of the mill stand is shown for clarity as a two-high formation, though the configuration is immaterial to this invention.

Though FIG. 4 shows the two strips following the paths 8 and 9 being separated for the re-application of the separating medium, this is not necessarily essential. If there is already sufficient release medium present between the strips from the previous pass, then additional medium may not be required.

If this is the final pass of the product, then the coil consisting of the two strips is taken to a separator, where the two strips are parted and coiled individually.

It will be seen that, whichever method is used to handle the strip between the doubling passes, the two strips, as they pass through the second doubling pass, are in the same or substantially the same registry with one another as when they passed through the first doubling pass.

It is well known that the two strips cannot be parted satisfactorily and without surface or strip damage, especially in thinner gauges, unless a release medium is applied between the strips. Although one of the conventional rolling oils, with or without additive packages, is the preferred medium, and is the most compatible with the oils used in strip rolling, alternative release materials may be employed, such as white spirit. The surface of the foil is sensitive to the amount and type of medium present. If excessive medium is present, this can form defects such as flecking and blisters. To minimise such defects when multiple pack rolling passes are used, it has been discovered that the amount of oil applied per metre of foil for each doubling pass after the first must be reduced to less than the amount applied prior to the first doubling pass. Preferably the amount of oil is less than half the amount applied prior to the first doubling pass and more preferably no additional oil is added between doubling passes. That is to say the minimum amount of additional oil that may be applied between two doubling passes is zero. Residual oil remains on the surface of the sheets after a doubling pass and is carried through to subsequent doubling passes. Where no oil is added between successive doubling passes the sheets need not be separated and instead the double layer of foil may be fed directly to the next mill stand or may be coiled for later rolling. This is conditional on the surface properties required, the gauges required and the total number of doubling passes used.

Although only one mill stand is shown in FIGS. 3 and 4 for pack rolling the metal foil, additional mill stands may be introduced for further pack rolling. Alternatively only one mill stand may be used with the double layer of foil being passed two or more times through the same mill stand. Although pack rolling is conventionally restricted to close-gap rolling, with multiple pack rolling open gap rolling may also be performed on the double layer of foil in the initial doubling passes.

The spray bars 4, 7 are conventional in design and comprise a header bar feeding a series of nozzles, which can be mist, cone or flat jet nozzles. A simpler arrangement whereby the medium just drips oil onto the sheet may also suffice. An alternative means for introducing oil onto the sheets is, for example, a perforated tube that is positioned between and in contact with one surface of each of the two sheets of foil. The interior of the perforated roll is connected to an oil supply so that the oil is able to pass through the perforations in its surface and be applied to the surface of each of the strips as they pass by. Oil may be applied to only one of the two strips on the surface of that strip that will later be in contact with th other of the strip. The oil may be applied on a separate apparatus for off-line doubling, using a conventional spray and where the two daughter strips are stored as coils for later multiple pack rolling, the oil may be sprayed onto the strip whilst it is being uncoiled or once the strip is free of the coil but prior to the strip contacting the other of the strip.

A typical pass schedule for conventionally producing household aluminium foil would be to start with strip 450 microns thick and then roll it down in successive passes to 215→100→47→23→10.5 microns with the last pass being the doubling pass. For a 10-tonne coil, 1700 mm wide, an approximate table of production times appears below as Table 1:

TABLE 1

| Entry | Exit | Entry | Exit | Mill | | Pass |
|---|---|---|---|---|---|---|
| Gauge | Gauge | Length | Length | Speed | Forward | Time |
| (micron) | (micron) | (m) | (m) | (mpm) | Slip | (min) |
| 450 | 215 | 4841 | 10133 | 600 | 10% | 15 |
| 215 | 100 | 10133 | 21786 | 900 | 15% | 21 |
| 100 | 47 | 21786 | 46354 | 900 | 20% | 43 |
| 47 | 23 | 46354 | 94724 | 900 | 25% | 84 |
| 2 × 23 | 2 × 10.5 | 94724 | 207490 | 600 | 25% | 138 |

If, in accordance with the present invention multiple pack rolling is performed and the “split pass” is doubled, then the total time is greatly reduced as shown in Table 2.

TABLE 2

| Entry | Exit | Entry | Exit | Mill | | Pass |
|---|---|---|---|---|---|---|
| Gauge | Gauge | Length | Length | Speed | Forward | Time |
| (micron) | (micron) | (m) | (m) | (mpm) | Slip | (min) |
| 450 | 215 | 4841 | 10133 | 600 | 10% | 15 |
| 215 | 100 | 10133 | 21786 | 900 | 15% | 21 |
| 100 | 47 | 21786 | 46354 | 900 | 20% | 43 |
| 2 × 47 | 2 × 23 | 46354 | 94724 | 900 | 20% | 44 |
| 2 × 23 | 2 × 10.5 | 94724 | 207490 | 600 | 25% | 138 |

The reduction in total contact time is 40 minutes or 13%.

For converter foil, a typical conventional pass schedule might be to start with strip 400 microns thick and then roll it down in successive passes to 220→55→26→14→6.5 microns with again the last pass being a doubling pass. Using the same coil size as set out above, Table 3 provides an approximation of the time required to roll a 10-tonne coil.

TABLE 3

| Entry | Exit | Entry | Exit | Mill | | Pass |
|---|---|---|---|---|---|---|
| Gauge | Gauge | Length | Length | Speed | Forward | Time |
| (micron) | (micron) | (m) | (m) | (mpm) | Slip | (min) |
| 450 | 220 | 4841 | 9903 | 700 | 10% | 13 |
| 220 | 110 | 9903 | 21786 | 1000 | 15% | 17 |
| 110 | 55 | 21786 | 39612 | 1000 | 20% | 33 |
| 55 | 26 | 39612 | 83794 | 1000 | 20% | 70 |
| 26 | 14 | 83794 | 155618 | 1000 | 25% | 124 |
| 2 × 14 | 2 × 6.5 | 155618 | 335176 | 700 | 25% | 192 |

Here too if, in accordance with the present invention, the split pass were to be doubled, 62 minutes would be saved (13% of total contact time). If additionally the second to last pass were to be doubled as well, a further 35 minutes would be saved (21% of total contact time).

The use of multiple pass pack rolling provides advantages in addition to the significant reduction in the overall contact time. As the foil gets thinner it becomes more susceptible to strip breaks and less able to accommodate strain differences. By doubling the strip in earlier passes, the entry gauge of the doubled foil is kept larger and so greater opportunities are afforded for increasing the reduction of the gauge and increasing the speed of the material through the mill stand. The thicker material is also less susceptible to edge damage permitting trimming of th edge material on the split pass to be omitted.

In the final doubling pass of a conventional rolling method using only a single doubling pass, the two daughter coils need to be well matched. However, it is often the case that near the start and near the end of the two daughter coils variations in gauge are encountered. Also, although Automatic Gauge Controllers may attempt to keep the gauge of the strip within tolerance along the length of the coil, there is a predominantly random pattern of gauge variation of the incoming strip. The peaks and troughs on gauge will therefore rarely coincide in the two strips unwound from the daughter coils. Strip flatness can vary too between daughter coils as a result of the reduction process itself but also as a result of the coiling process. The strip profile (meaning the variation in thickness across the width of the strip), although only a slowly varying function, does vary over the length of the strip. When two daughter strips are overlaid, the lead-in profiles and finishing profiles come from one end of the original coil and from the middle of the original coil and so are unlikely to match. Such a difference is exaggerated when the two daughter coils are paid off in opposite senses, i.e. over-wound and under-wound, in which case the profile of one coil is the mirror of that of the other. Finally, it is frequently the case that unrelated coils are used, for example where a small coil (sometimes called a ‘dog-end’) is used to match lengths. In such cases it is extremely unlikely that the two strips used in the final doubling pass will match. Multiple pack rolling also reduces problems that are generally encountered in the use of a conventional final doubling pass. The thicker gauge of the material in the first doubling pass is more forgiving of any mismatch and in the one or more subsequent doubling passes the two strips are better matched as a result of having passed once already together.

The results of two separate trials using the above described multiple pack rolling method are set out below.

### Trial 1

One 1310 mm wide pack rolled coil of AA8000 series foil consisting of two strips each having a gauge of 18 microns was produced by a conventional method using a final doubling pass. With the strips remaining in register and without further addition of oil between them, the coil was brought to the mill stand for a second doubling pass that reduced the thickness of each strip to 10.5 micron gauge. The loads and speeds for this pass were comparable with those for a conventional final pass.

The rolls were worn and resulted in repeated breaking of the strips. However, the surface appearance of the matt surface of the strips was very good and free of blemishes. The strips were tested using a LECO (Trade Name) to check the residual oil levels. As no additional oil had been added the total carbon for the exit material should be less than that of the entry material. Whilst there was a small reduction in measured carbon levels the reduction was not significant. This could be because the total carbon is dominated by the residual oil on the bright surface.

Topographical measurements of the matt and bright surfaces were also carried out. The average roughness of the surfaces are set out in Table 4 below, in which:—

Ra is the Roughness Average. In this case the arithmetic average height is calculated across the area of the sample measured (conventionally it is calculated along a line); and

Rz is the average of the five greatest peak-to-valley separations.

TABLE 4

| | | Foil | | |
|---|---|---|---|---|
| | | Thickness | Ra | Rz |
| Pass | Sample | (μm) | (μm) | (μm) |
| First pack | Bright side | 18 | 0.237 ± 0.025 | 2.671 ± 0.605 |
| rolling | Upper strip | | | |
| (doubling) | Matt side | 18 | 0.450 ± 0.017 | 5.468 ± 0.597 |
| pass | Upper strip | | | |
| | Bright side | 18 | 0.241 ± 0.029 | 2.628 ± 0.280 |
| | Lower strip | | | |
| | Matt side | 18 | 0.464 ± 0.020 | 5.352 ± 0.288 |
| | Lower strip | | | |
| Second | Bright side | 10.5 | 0.241 ± 0.007 | 2.516 ± 0.175 |
| pack rolling | Upper strip | | | |
| (doubling) | Matt side | 10.5 | 0.580 ± 0.025 | 6.289 ± 0.261 |
| pass | Upper strip | | | |
| | Bright side | 10.5 | 0.254 ± 0.015 | 2.728 ± 0.180 |
| | Lower strip | | | |
| | Matt side | 10.5 | 0.572 ± 0.022 | 6.345 ± 0.405 |
| | Lower strip | | | |

### Trial 2

A 1565 mm wide coil of 8006 aluminium alloy 1.2 k.i.m. was rolled for three passes through a first mill with successive exit gauges 215, 116 and 55 μm. Two doubling passes were then performed on a second mill with successive exit gauges 27 and 13 μm. At each of the doubling passes the coil was trimmed; first down to 1520 mm and then to 1490 mm. The strips were then separated and annealed. The doubled strips were not separated and no oil was added between the two doubling passes. For reasons unrelated to the multiple pack rolling method there was a time delay of two months before a third doubling pass was performed on the coil. Table 5 sets out the mill conditions for each of the six passes.

TABLE 5

| | | | | | | Payoff | Rewind |
|---|---|---|---|---|---|---|---|
| | | | | | | sp. | sp. |
| | Exit | Av. | Av. | Entry | Exit | tens | tens |
| | Width | Speed | Load | Gauge | Gauge | kgf/ | kgf/ |
| Pass | (mm) | (mpm) | (t) | (μ) | (μ) | mm² | mm² |
| 1 | 1565 | 808 | 324 | 450 | 215 | 1.58 | 5.43 |
| 2 | 1565 | 653 | 297 | 215 | 116 | 3.41 | 4.66 |
| 3 | 1565 | 1017 | 258 | 116 | 55 | 6.49 | 6.04 |
| 4 | 1565 | 847 | 301 | 116 | 55 | 5.89 | 6.17 |
| 5 | 1520 | 582 | 363 | 110 | 54 | 3.97 | 5.10 |
| 6 | 1490 | 686 | 373 | 54 | 26 | 7.23 | 4.83 |

After the successful final doubling pass a sample of the final strip was analysed. The roughness results for the matt side of a sample of strip from near the end of the coil was Ra=0.539 microns. For comparison, for conventional 8006 alloy Ra=0.454 microns. The topography results were also good. The coil was separated and further samples taken from near the start of the coil:

TABLE 6

| | | Ra | Rz |
|---|---|---|---|
| Sample | Side | (μm) | (μm) |
| Upper centre | Matt | 0.61+/−0.07 | 7.55+/−1.96 |
| Upper centre | Bright | 0.24+/−0.02 | 3.23+/−0.34 |
| Lower centre | Matt | 0.62+/−0.02 | 12.94+/−3.50 |
| Lower centre | Bright | 0.24+/−0.04 | 2.81+/−0.43 |

The topography was again good although the matt surface exhibited some spots which are believed to have resulted from the long interval between the doubling passes that allowed some separating oil to evaporate. A sample was put through a simulated anneal. The whole coil was subsequently annealed in plant. The resultant coil had to meet the following specification: UTS: 105; Elongation: 3.5; Burst Strength: 90. The measured values for the material at 13.6 microns thickness exceeded the specification as shown below:

TABLE 7

| UTS | Elongation | Burst Strength |
|---|---|---|
| 109 | 4.2 | 99 |
| 111 | 4.7 | 99 |
| 111 | 5.1 | 104 |
| | | 104 |
| | | 104 |
| | | 104 |

The simulated annealed sample were:

TABLE 8

| | | 0.2% | | | |
|---|---|---|---|---|---|
| | | Proof | | | Burst |
| | Spot Gauge | Stress | UTS | Elongation | Strength |
| | (μm) | (Mpa) | (MPa) | (%) | (kPa) |
| Upper | 14.10 | 82.0 | 103.0 | 3.5 | 113 |
| Lower | 13.45 | 82.1 | 99.6 | 2.7 | 100 |

### Further Trails

Further trials have been made varying the additional oil applied between doubling passes, and trials have also been made when the doubling has been done on a separate machine.

1. Foil rolling method for producing thin gauge aluminium foil, said method comprising the steps of: providing two strips of aluminium; bringing the facing surfaces of the two strips into contact; and pack rolling the two strips, the method further comprising pack rolling the two strips at least once more wherein the second and any subsequent pack rolling steps are carried out with the two strips in the same, or substantially the same registry as when the first pack rolling step was carried out.

2. Foil rolling method as claimed in claim 1 including applying a release material to a facing surface of at least one of the strips prior to the first pack rolling step, and applying a further amount of release material to the facing surfaces of the strips between the two pack rolling steps, said further amount of release material being less than the amount applied prior to the previous pack rolling step.

3. Foil rolling method as claimed in claim 2 wherein no release material is applied between the two pack rolling steps.

4. Foil rolling method as claimed in claim 3 wherein the two strips are not separated between the two pack rolling steps.

5. Foil rolling method as claimed in any one of the preceding claims wherein at least one of the pack rolling steps is open gap rolling.

6. Foil rolling method as claimed in any one of the preceding claims wherein the release material is rolling oil, with or without additives

7. Foil rolling method as claimed in any one of the preceding claims comprising the initial steps of providing a strip of aluminium; passing the strip through at least one set of rolls thereby reducing the gauge of the strip and dividing the strip laterally into two strips for pack rolling.

8. Foil rolling method as claimed in any one of the preceding claims wher in, following the first pack rolling step, the two strips are coiled together onto a common coil whilst substantially retaining their registry, one with the other, and wherein, prior to the second pack rolling step, the two strips are uncoiled together from the coil.

9. Foil rolling method as claimed in any one of the preceding claims wherein, after the final pack rolling step, the two strips are coiled together onto a common coil.

10. Foil rolling method as claimed in claim 9 wherein the two strips are subsequently uncoiled together from the common coil, are separated and thence individually coiled onto separate coils.
